(19) United States
(12) Patent Application Publication
(10) Pub. No.: US 2025/0271329 A1
(43) Pub. Date: Aug. 28, 2025

(54) TEST FIXTURE FOR ACCELERATED TESTING OF DIFFERENT LOADS

(71) Applicant: International Truck Intellectual Property Company, LLC, Lisle, IL (US)

(72) Inventor: Timothy M. Lyons, Batavia, IL (US)

(73) Assignee: International Truck Intellectual Property Company, LLC, Lisle, IL (US)

(21) Appl. No.: 18/587,136

(22) Filed: Feb. 26, 2024

(51) Int. Cl. G01M 13/026

(52) U.S. Cl. CPC G01M 13/026

(57) ABSTRACT

A test fixture for accelerated testing of different loads includes a fixture shaft adapted to be detachably connected to a test shaft. A pulley is fixedly supported by the fixture shaft. A cable has a first end fixedly attached to the pulley and a second end detachably attached to a test mass.

### FIELD OF THE INVENTION

The present disclosure relates generally to a test fixture and, more particularly, to a test fixture for a rotating shaft or gear train that allows for rapid changes to test different loads as well as a varying load within a given load cycle.

### BACKGROUND

In product development, there are often several different material and design concepts for a particular mechanism, for example, without limitation, an electric door motor gear assembly used to open and close the entry doors of a school bus. The different design concepts need to be tested to determine which is the most desirable or robust. In the past, various bench testing techniques have been used to apply fixed loads to a rotating shaft or gear train over various cycles and durations. However, it is sometimes necessary to perform accelerated testing to quickly quantify the differences among different design concepts.

A need therefore exists for a test fixture that allows for rapid changes to applied test loads as well the ability to vary the applied load within a given load cycle. It would be beneficial if the test load could be quickly changed to achieve a different but constant motor or gear load. It would be further beneficial if the load applied in a load cycle could be easily varied, for example without limitation, to add an increased load near the beginning or near the end of the load cycle. It would be further beneficial if the test fixture is relatively compact and adaptable to many gear designs.

### SUMMARY OF THE INVENTION

In one aspect of the invention, a test fixture for accelerated testing comprises a fixture shaft adapted to be detachably connected to a test shaft. A pulley is fixedly supported by the fixture shaft. A cable has a first end fixedly attached to the pulley and a second end detachably attached to a test mass.

In another aspect of the invention, a test fixture for accelerated testing comprises a fixture shaft adapted to be connected to a test shaft. A pulley is fixedly supported by the fixture shaft. A cable has a first end fixedly attached to the pulley and a second end detachably attached to a test mass of a plurality of distinct test masses, and the fixture shaft includes bearings disposed to support rotation of the fixture shaft.

In a further aspect of the invention, a test fixture for accelerated testing comprises a fixture shaft adapted to be connected to a test shaft. A pulley is fixedly supported by the fixture shaft, and bearings are disposed on the fixture shaft to support rotation of the fixture shaft. A cable has a first end fixedly attached to the pulley and a second end detachably attached to a test mass of a plurality of distinct test masses. A spring is attached to a fixed surface disposed between the test mass and the pulley and configured so that when rotation of the pulley wraps the cable to lift the test mass, the spring is in the path of the test mass.

### BRIEF DESCRIPTION OF THE DRAWINGS

The foregoing and other features of the present disclosure will become more fully apparent from the following description and appended claims, taken in conjunction with the accompanying drawings. These drawings depict only several exemplary embodiments in accordance with the disclosure and are, therefore, not to be considered limiting of the scope of the present disclosure.

FIG. 1 is a first schematic view of a test fixture according to an exemplary embodiment.

FIG. 2 is a second schematic view of the test fixture of FIG. 1.

FIG. 3 illustrates the steps of an exemplary method for using the test fixture of FIGS. 1 and 2.

FIG. 4 is a first schematic view of a test fixture according to another exemplary embodiment.

FIG. 5 is a second schematic view of the test fixture of FIG. 4.

FIG. 6 illustrates the steps of an exemplary method for using the test fixture of FIGS. 4 and 5.

In the following detailed description, various exemplary embodiments are described with reference to the appended drawings. The skilled person will understand that the accompanying drawings are schematic and simplified for clarity. Like reference numerals refer to like elements or components throughout. Like elements or components will therefore not necessarily be described in detail with respect to each figure.

### DETAILED DESCRIPTION

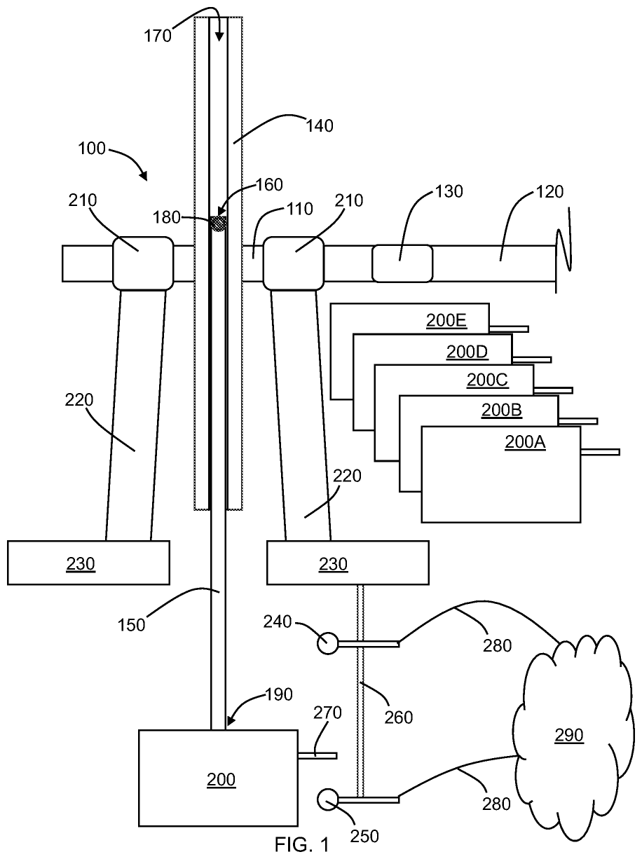

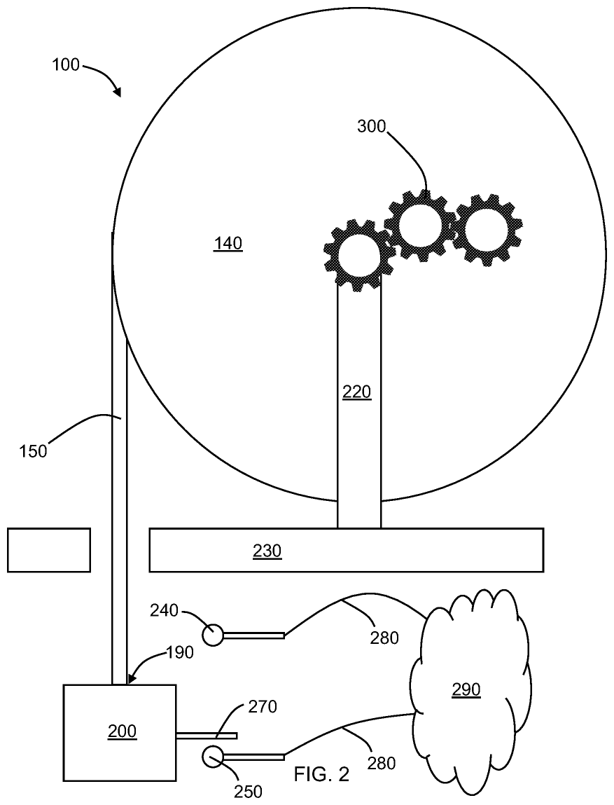

Referring to FIGS. 1 and 2, two views of an exemplary embodiment of test fixture 100 for accelerated testing is shown. In accordance with an exemplary embodiment, test fixture 100 comprises fixture shaft 110 that is adapted to be detachably connected to test shaft 120. In an exemplary embodiment, coupling 130 is used to make the detachable connection. For example, without limitation, coupling 130 is a beam shaft or rigid shaft coupling.

Pulley 140 is shown edge-on in FIG. 1 and along an axis of rotation in FIG. 2 and is preferably fixedly supported by fixture shaft 110, so that a rotation of fixture shaft 110 results in an equal rotation of pulley 140. In an exemplary embodiment, cable or wire 150 has a first end 160 that is fixedly attached to pulley 140. For example without limitation, first end 160 is fastened into a groove 170 of pulley 140 by a fastener like a screw or bolt 180, or first end 160 can be welded or otherwise fixedly attached to pulley 140. In an exemplary embodiment, rotation of pulley 140 results in cable or wire 150 being wrapped onto or unwrapped from pulley 140. In an exemplary embodiment, second end 190 of cable or wire 150 is detachably attached to test mass 200.

In an exemplary embodiment as shown in FIG. 1, test mass 200 is one of a plurality of test masses 200, 200A, 200B, etc., that detachably attach to second end 190, wherein each of the plurality of test masses 200, 200A, 200B, etc., has a distinct mass, illustrated in FIG. 1 for example without limitation, as the test masses 200, 200A, 200B, 200C, 200D, and 200E, where each different reference numeral is representative of having a distinct mass. In any exemplary embodiment, there can be as many or as few of the plurality of test masses 200, 200A, 200B, etc. For example, 200, 200A, 200B, . . . , through 200Z, as are desired for quick and easy changing of the load applied. In an exemplary embodiment, test masses 200, 200A, 200B, etc., are incremented in weight by a fixed amount and/or are labeled by their weight for easy recognition by a technician. In an exemplary embodiment, the test masses 200, 200A, 200B, etc., detachably attach to second end 190 by a hook on second end 190 attaching around a bar or loop on test mass 200, or by a hook extending from test mass 200 attaching around a loop in second end 190, or by a quick release latch, or by any mechanism for detachable connection as is known in the art.

In an exemplary embodiment, test fixture 100 further comprises bearings 210 disposed on fixture shaft 110 to support rotation of fixture shaft 110. For example, without limitation as shown in FIG. 1, bearings 210 can in turn be supported by support arms 220 extending from bench or tabletop 230. Without being held to theory, bearings 210 allow for test masses 200, 200A, 200B, etc., to be supported by pulley 140 without causing an unwanted bending stress in fixture shaft 110 across pulley 140.

Still referring to FIGS. 1 and 2, in an exemplary embodiment test fixture 100 further comprises at least one of an upper counter switch or contact 240 and a lower counter switch or contact 250 supported below pulley 140. For example, in an exemplary embodiment upper and lower counter switches or contacts 240 and 250 can be physically supported on member 260 that extends from bench or tabletop 230. In an exemplary embodiment, each of test masses 200, 200A, 200B, etc., further comprise counter arm 270 that is configured to make contact with each of the upper and lower counter contacts 240 and 250, or close each of the upper and lower contact switches 240 and 250 upon contact. In an exemplary embodiment, each of the upper and lower counter switches or contacts 240 and 250 is connected, either wirelessly or via a wired connection 280, to supporting computer hardware, software, and data storage memory 290 (shown schematically as a cloud 290) for recording the number of contacts/switch closures.

Referring to FIG. 2, in an exemplary embodiment, test shaft 120 is connected to gear train 300 or other structure or mechanism 300 to which a test load is to be applied. In operation, gear train 300 is preferably driven as it would be in actual use, for example by driving motor (not shown) in first and second directions which causes test shaft 120 together with fixture shaft 110 to rotate in first and second opposite directions, which, in turn, rotates pulley 140 in first and second opposite directions, thus raising and lowering test mass 200.

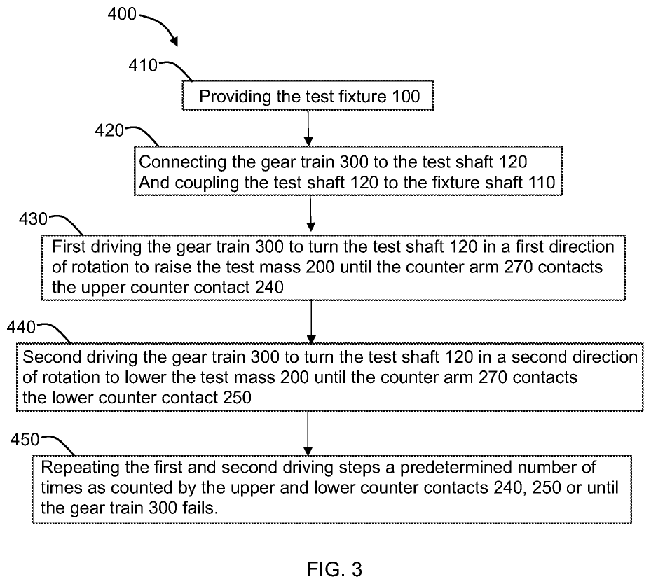

Referring now to FIG. 3, in an exemplary embodiment, a method 400 for testing a gear train 300 or other structure or mechanism 300 begins with step 410 of providing test fixture 100 comprising upper counter contact 240 and lower counter contact 250. At step 420, gear train 300 is connected to test shaft 120, which is preferably coupled to fixture shaft 110, for example via coupler 130. At step 430, gear train 300 is first driven to turn test shaft 120 in a first direction of rotation to raise test mass 200 until counter arm 270 contacts upper counter contact 240 or closes upper counter switch 240. At step 440, gear train 300 is second driven to turn test shaft 120 in a second direction of rotation to lower test mass 200 until counter arm 270 contacts lower counter contact 250 or closes lower counter switch 250. At step 450, first and second driving steps 430 and 440 are repeated a predetermined number of times as counted by upper and lower counter contacts (or switches) 240, 250 or until gear train 300 fails.

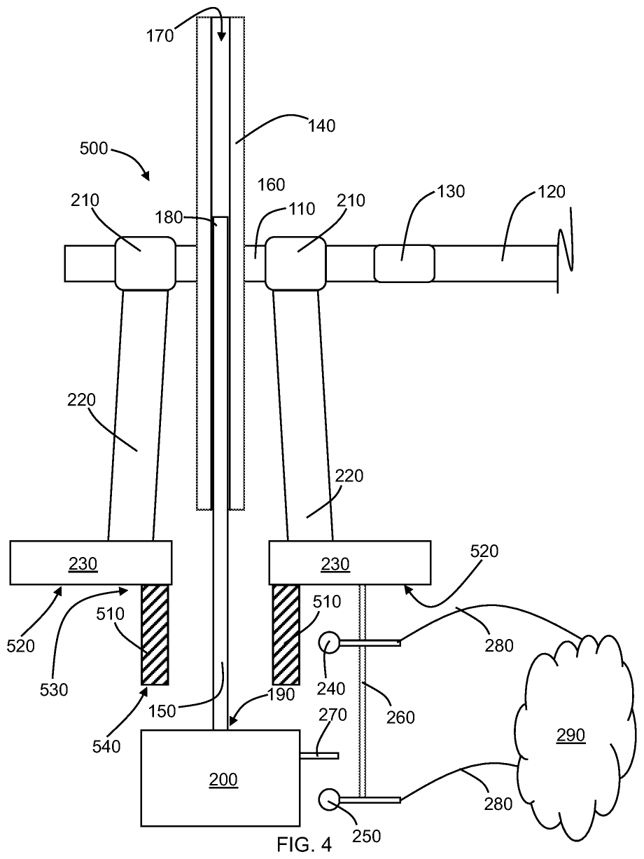

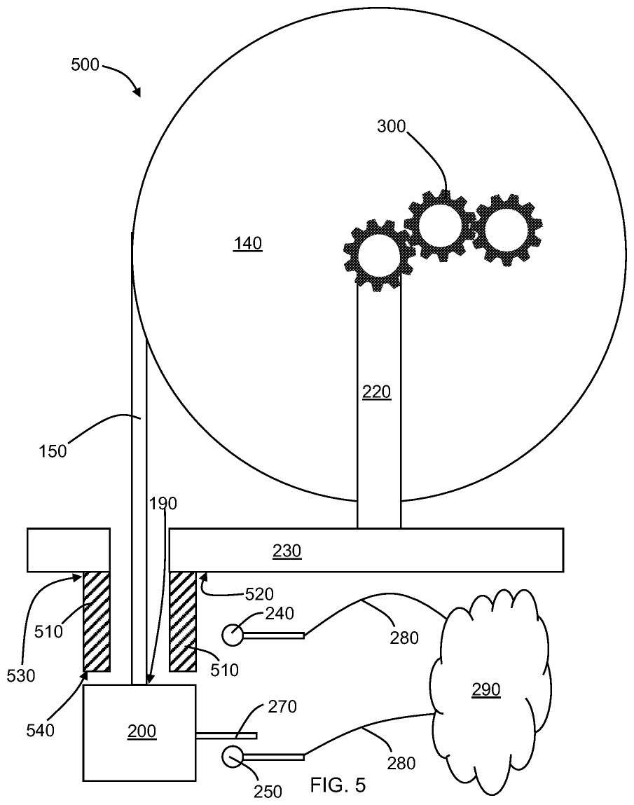

Referring now to FIGS. 4 and 5, an exemplary embodiment of test fixture 500 is similar to test fixture 100 described hereinabove with regard to FIGS. 1 and 2. All of the same structures present in test fixture 500 are labeled with the same reference numerals as were used in the description of test fixture 100 above. However, text fixture 500 includes additional structure not present in test fixture 100, as is described fully hereinbelow.

Whereas test fixture 100 can be used to provide a constant load on gear train 300 or other mechanism to be tested 300, the exemplary embodiment of test fixture 500 allows for an applied load to be varied through the load cycle. In an exemplary embodiment, test fixture 500 further comprises spring 510 or pair of springs 510 attached to fixed surface 520 that is disposed between test mass 200 and pulley 140. For example, without limitation, in an exemplary embodiment, spring or springs 510 are detachably attached at first end 530 to bottom surface 520 of bench or tabletop 230. Spring or springs 510 are configured to compress vertically in FIGS. 4 and 5, so that when rotation of pulley 140 wraps wire or cable 150 to lift test mass 200, spring or springs 510 are in the path of test mass 200. As test mass 200 rises, spring or springs 510 get compressed. Without being held to theory, the force, F that results from a compressed spring varies linearly with the distance of compression X. Mathematically, this is usually written as F=−kX, where k is commonly known as the spring constant. In effect, the presence of spring or springs 510 causes the force applied by hanging mass 200 to increase by an amount equal to the compression force of spring or springs 510, which allows each load cycle to have a variable load.

Still referring to FIGS. 4 and 5, the exemplary embodiment of test fixture 500 also comprises upper and lower counter switches or contacts 240, 250 supported below fixed surface 520. Test mass 200 further comprises counter arm 270 configured to make contact with each of upper and lower counter contacts 240, 250, or close each of the upper and lower upon contact switches 240, 250 upon contact. However, in the embodiment of test fixture 500 upper counter contact or switch 240 is disposed closer to fixed surface 520 than second end 540 of spring or springs 510 so that test mass 200 compresses spring or springs 510 when counter arm 270 makes contact with upper counter contact or switch 240.

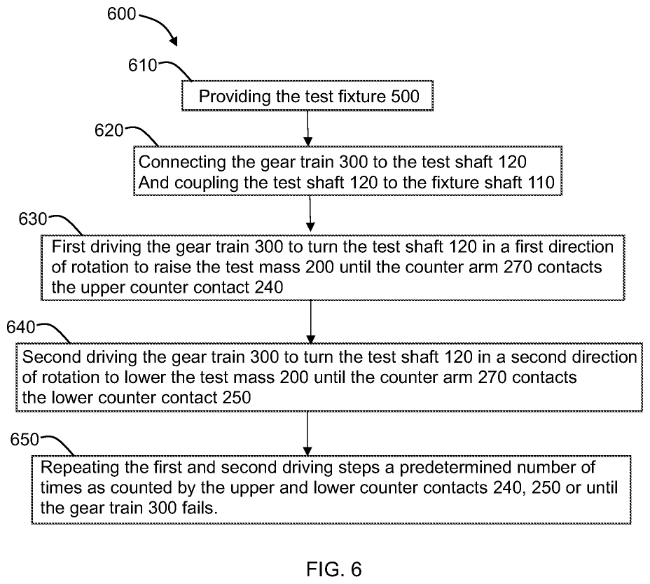

Referring now to FIG. 6, in an exemplary embodiment, method 600 for testing gear train 300 or other structure or mechanism 300 begins with step 610 of providing test fixture 500 comprising upper counter contact 240 and lower counter contact 250. At step 620, gear train 300 is connected to test shaft 120, which is coupled to fixture shaft 110, for example via coupler 130. At step 630, gear train 300 is first driven to turn test shaft 120 in a first direction of rotation to raise test mass 200 until counter arm 270 contacts upper counter contact 240 or closes upper counter switch 240. At step 640, gear train 300 is second driven to turn test shaft 120 in a second direction of rotation to lower test mass 200 until counter arm 270 contacts lower counter contact 250 or closes lower counter switch 250. It should be noted that in the exemplary method 600, step 630 also preferably compresses spring or springs 510, which adds additional load to the end of first driving step 630 and to the beginning of second driving step 640. At step 650, first and second driving steps 430 and 440 are repeated a predetermined number of times as counted by upper and lower counter contacts (or switches) 240, 250 or until gear train 300 fails. Other methods for using test fixtures 100, 500 include executing one of the methods 400, 600 for a predetermined number of cycles, changing test mass 200, repeating the executed method 400, 600, changing test mass 200, etc., wherein test mass 200 is changed as many times as is desired, a predetermined number of times, or until gear train 300 fails.

It should be noted that, in an accordance with an exemplary embodiment, additional controlling processors, memory, and communications hardware and software are present within cloud 290 for controlling the number of predetermined cycles and the duration of each cycle applied to the test fixture 100, 500 in the methods 400, 600 and other methods as described above, and for storing data including the number of cycles executed, as well as stresses on gear train 300 or other mechanism being tested 300 as measured by strain gauges or other stress-measuring tools.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

### INDUSTRIAL APPLICABILITY

A test fixture for load testing gear trains and driven rotating shafts is presented, which allows for rapid changes to applied test loads as well the ability to vary the applied load within a given load cycle. The test fixture is relatively compact and adaptable to many gear designs. The test fixture can be manufactured in industry for use by consumers and manufacturers of machinery having rotating shafts and driven gear trains.

Numerous modifications to the present invention will be apparent to those skilled in the art in view of the foregoing description. It is not desired to limit the invention to the exact construction and operation shown and described and, accordingly, all suitable modifications and equivalents may be resorted to falling within the scope of the invention. Accordingly, this description is to be construed as illustrative only of the principles of the invention and is presented for the purpose of enabling those skilled in the art to make and use the invention and to teach the best mode of carrying out same. The exclusive rights to all modifications which come within the scope of the appended claims are reserved. All patents, patent publications and applications, and other references cited herein are incorporated by reference herein in their entirety.

I claim:

1. A test fixture for accelerated testing comprising:
a fixture shaft adapted to be detachably connected to a test shaft;
a pulley fixedly supported by the fixture shaft; and
a cable having a first end fixedly attached to the pulley and a second end detachably attached to a test mass.

2. The test fixture of claim 1, further comprising bearings disposed on the fixture shaft to support rotation of the fixture shaft.

3. The test fixture of claim 1, further comprising a plurality of additional test masses that detachably attach to the second end, wherein each of the plurality of additional test masses has a distinct mass.

4. The test fixture of claim 1, wherein the test shaft is connected to a gear train.

5. The test fixture of claim 1, further comprising at least one of an upper counter contact and a lower counter contact supported below the pulley, wherein the test mass further comprises a counter arm configured to make contact with the at least one of the upper counter contact and the lower counter contact.

6. A method for load testing a gear train, the method comprising the steps of:
providing the test fixture of claim 5 comprising the upper counter contact and the lower counter contact;
connecting a gear train to the test shaft;
coupling the test shaft to the fixture shaft;
first driving the gear train to turn the test shaft in a first direction of rotation to raise the test mass until the counter arm contacts the upper counter contact;
second driving the gear train to turn the test shaft in a second direction of rotation to lower the test mass until the counter arm contacts the lower counter contact; and
repeating the first and second driving steps a predetermined number of times as counted by the upper counter contact and the lower counter contact or until the gear train fails.

7. The test fixture of claim 1, further comprising a spring attached to a fixed surface disposed between the test mass and the pulley and configured so that when rotation of the pulley wraps the cable to lift the test mass, the spring is in the path of the test mass.

8. The test fixture of claim 7, wherein an upper counter contact and a lower counter contact are supported below the fixed surface, and wherein the test mass further comprises a counter arm configured to make contact with the upper counter contact and the lower counter contact.

9. The test fixture of claim 8, wherein the upper counter contact is disposed closer to the fixed surface than the spring so that the test mass compresses the spring when the counter arm makes contact with the upper counter contact.

10. A test fixture for accelerated testing comprising:
a fixture shaft adapted to be connected to a test shaft;
a pulley fixedly supported by the fixture shaft;
a cable having a first end fixedly attached to the pulley and a second end detachably attached to a test mass; and
wherein the fixture shaft includes bearings disposed to support rotation of the fixture shaft.

11. The test fixture of claim 10, wherein the test shaft is connected to a gear train.

12. The test fixture of claim 10, further comprising a spring attached to a fixed surface disposed between the test mass and the pulley and configured so that when rotation of the pulley wraps the cable to lift the test mass; the spring is in the path of the test mass.

13. The test fixture of claim 12, further comprising at least one of an upper counter contact and a lower counter contact supported below the fixed surface, wherein the test mass further comprises a counter arm configured to make contact with the at least one of the upper counter contact and the lower counter contact.

14. The test fixture of claim 13, wherein the upper counter contact is disposed closer to the fixed surface than the spring so that the test mass compresses the spring when the counter arm makes contact with the upper counter contact.

15. A method for load testing a gear train, the method comprising the steps of:
providing the test fixture of claim 14 comprising the upper counter contact and the lower counter contact;
connecting the gear train to the test shaft;
coupling the test shaft to the fixture shaft;
first driving the gear train to turn the test shaft in a first direction of rotation to raise the test mass until the counter arm contacts the upper counter contact;
second driving the gear train to turn the test shaft in a second direction of rotation to lower the test mass until the counter arm contacts the lower counter contact; and
repeating the first and second driving steps a predetermined number of times as counted by the upper counter contact and the lower counter contact or until the gear train fails.

16. A test fixture for accelerated testing, the fixture comprising:
a fixture shaft adapted to be connected to a test shaft;
a pulley fixedly supported by the fixture shaft;
bearings disposed on the fixture shaft to support rotation of the fixture shaft;
a cable having a first end fixedly attached to the pulley and a second end detachably attached to a test mass; and
a spring attached to a fixed surface disposed between the test mass and the pulley and configured so that when rotation of the pulley wraps the cable to lift the test mass, the spring is in the path of the test mass.

17. The test fixture of claim 16, wherein the test shaft is coupled to a gear train.

18. The test fixture of claim 16, further comprising at least one of an upper counter contact and a lower counter contact supported below the fixed surface, wherein the test mass further comprises a counter arm configured to make contact with the upper counter contact and the lower counter contact.

19. The test fixture of claim 18, wherein the upper counter contact is disposed closer to the fixed surface than the spring so that the test mass compresses the spring when the counter arm makes contact with the upper counter contact.

20. The test fixture of claim 18 comprising the upper counter contact and the lower counter contact.
